(19) United States
(12) Patent Application Publication
(10) Pub. No.: US 2026/0039061 A1
(43) Pub. Date: Feb. 5, 2026

(54) CONNECTOR SET AND CONNECTOR ASSEMBLY

(71) Applicant: Nippon Tanshi Co., Ltd., Hiratsuka-shi, Kanagawa (JP)

(72) Inventors: Shinya ENOMOTO, Kanagawa (JP); Osamu NISHIMURA, Kanagawa (JP)

(21) Appl. No.: 18/997,696

(22) PCT Filed: Jun. 26, 2023
(86) PCT No.: PCT/JP2023/023530

§ 371 Date: Jan. 22, 2025

(30) Foreign Application Priority Data
Jul. 22, 2022 (JP) 2022-117359

(51) Int. Cl. H01R 13/64; H01R 12/72; H01R 13/50

(52) U.S. Cl. CPC H01R 13/64; H01R 12/721; H01R 13/50

(57) ABSTRACT

In a connector set including a first card edge connector and a second card edge connector, the first card edge connector and the second card edge connector each comprise a plurality of walls defining an insertion hole for receiving a corresponding end of a circuit board, and at least one of the walls of the first card edge connector consists of an incorrect insertion preventing wall which has a rear end with respect to an insertion direction of the circuit board different from a corresponding rear end of the second card edge connector.

### TECHNICAL FIELD

The present invention relates to a connector set including a pair of card edge connectors, and a connector assembly including a connector set and a pair of cards configured to be connected to the card edge connectors of the connector set, wherein the connector set and the connector assembly are configured to prevent incorrect fitting.

### BACKGROUND ART

A connector assembly configured to prevent incorrect connection between connectors other than correct connectors is known in the art (for example, Patent Document 1). The connector assembly disclosed in Patent Document 1 includes a first connector and a second connector. The first connector has a first surface from which a circuit board extends orthogonally to the first surface. The second connector has a second surface formed with an insertion opening into which the circuit board of the first connector is to be inserted.

A plurality of first holes is formed on the first surface of the first connector, and a plurality of second holes is formed on the second surface of the second connector at positions corresponding to the first holes. Incorrect insertion preventing pins are fitted into some of the first holes provided on the first surface to be closed thereby. Stud pins are fitted into some of the second holes so as to project from the second surface.

When the circuit board of the first connector is pushed into the insertion opening of a correct second connector, the stud pins fit into the corresponding second holes provided on the second surface, and the first connector can be correctly connected to the second connector. On the other hand, when an attempt is made to push the circuit board of the first connector into the insertion slot of an incorrect second connector, the stud pins abut against the incorrect insertion preventing pins so that the first connector is prevented from being connected to the incorrect second connector.

### PRIOR ART DOCUMENT(S)

### Patent Document(s)

Patent Document 1: JP2012-209102A

### SUMMARY OF THE INVENTION

### Task to be Accomplished by the Invention

In the connector assembly disclosed in Patent Document 1, a first connector is provided on a circuit board, and incorrect insertion preventing pins are fitted into a first surface of the first connector while a second surface of a second connector into which the circuit board of the first connector is to inserted is fitted with incorrect insertion preventing pins so as to project from the second surface with the result that incorrect mating to the two connectors can be prevented.

However, there may be cases where the first surface cannot be provided on the first connector. In such a case, the first holes cannot be provided in the first connector so that the connector assembly disclosed in Patent Document 1 cannot be formed.

In view of the above background, a primary object of the present invention is to provide a connector set and a connector assembly that can prevent incorrect fitting between an edge of a circuit board and a card edge connector that do not correspond to each other.

### Means to Accomplish the Task

In order to accomplish such a task, an aspect of the present invention provides a connector set (9, 83) including a first card edge connector (7A) and a second card edge connector (7B), wherein the first card edge connector and the second card edge connector each comprise a plurality of walls (31, 33, 35, 37, 39, 41) defining an insertion hole (11) for receiving a corresponding end of a circuit board, and at least one of the walls of the first card edge connector consists of an incorrect insertion preventing wall (37A, 35B, 91A) which has a rear end with respect to an insertion direction of the circuit board different from a corresponding rear end of the second card edge connector.

According to this aspect, by providing a cutout in the edge part of the circuit board configured to be inserted into the second edge connector in such a manner that the incorrect insertion preventing wall cannot fit into the cutout and the wall of the second edge connector corresponding to the incorrect insertion preventing wall can fit into the cutout, the edge part of the circuit board configured to the inserted into the second edge connector is prevented to being inserted into the first edge connector. Thereby, by using the connector set configured in this manner, incorrect insertion of an edge part of a circuit board into a card edge connector can be prevented.

In the above aspect, preferably, the incorrect insertion preventing wall defines an outer boundary of an end surface of the circuit board inserted into the insertion hole.

According to this aspect, it is possible to provide the first card edge connector with the incorrect insertion preventing wall with a simple configuration.

In the above aspect, preferably, the incorrect insertion preventing wall forms a partition wall of the insertion hole.

According to this aspect, it is possible to provide the first card edge connector with the wall for preventing incorrect insertion with a simple configuration.

In the above aspect, preferably, the incorrect insertion preventing wall protrudes from the corresponding wall of the second card edge connector in a direction opposite to the insertion direction of the circuit board.

According to this aspect, distinction between the first card edge connector and the second card edge connector is simplified.

In the above aspect, preferably, the first card edge connector and the second card edge connector each have an upper wall (31) defining a boundary on a front side of the circuit board received in the insertion hole and a lower wall (33) defining a boundary on a back side of the circuit board, and a rib (49, 93) is provided between the incorrect insertion preventing wall and at least one of the upper wall and the lower wall so as to connect these two parts.

According to this aspect, the rigidity of the incorrect insertion preventing wall can be increased.

To accomplish such a task, another aspect of the present invention provides a connector assembly (1, 81), comprising the connector set described above, and a card edge set (5, 85) including a first card edge (3A) forming an end of the circuit board and configured to be inserted into the first card edge connector and a second card edge (3B) forming an end of the circuit board and configured to be inserted into the second card edge connector, wherein the first card edge is provided with a first cutout (15AL, 15AR) cut out from an edge thereof in the insertion direction and configured to accept the incorrect insertion preventing wall, and the second card edge is provided with a second cutout (15BL, 15BR) cut out from an edge thereof in the insertion direction so as to accept the wall of the second edge connector corresponding to the incorrect insertion preventing wall but not to accept the incorrect insertion preventing wall.

According to this aspect, since the incorrect insertion preventing wall of the first card edge cannot be fitted into the cutout provided in the second card edge, incorrect fitting of the second card edge to the first card edge connector can be prevented.

In the above aspect, preferably the first cutout has a longer cutout length than the second cutout.

According to this aspect, the cutout for accepting the incorrect insertion preventing wall and the cutout for not accepting the incorrect insertion preventing wall but accepting the wall of the second card edge connector corresponding to the incorrect insertion preventing wall can be constructed by using a simple structure.

### Effect of the Invention

According to the above aspects, a connector set and a connector assembly that prevent incorrect fitting between an edge of a circuit board and a card edge connector that do not correspond to each other can be prevented.

### BRIEF DESCRIPTION OF THE DRAWINGS(S)

FIG. 1 A perspective view showing (A) a first edge connector, (B) a second edge connector, (C) a first card edge, and (D) a second card edge that are included in a connector assembly according to a first embodiment of the present invention

FIG. 2 A top view showing (A) a state where the first edge connector is correctly fitted with the first card edge connector and (B) a state where the second edge connector is correctly fitted with the second card edge connector

FIG. 3 A sectional view taken along line III-III of FIG. 2

FIG. 4 A perspective view of the first edge connector partly in section taken along line IV-IV of FIG. 1

FIG. 5 A perspective view of a connector member

FIG. 6 A top view of (A) a state where the second edge connector is fitted with the first card edge and (B) a state where the first edge connector is fitted with the second card edge

FIG. 7 A sectional view taken along line VII-VII of FIG. 7

FIG. 8 A top view showing (A) a state where the first edge connector is fitted with the first card edge in an inverted state and (B) a state where the second edge connector is fitted with the second card edge in an inverted state

FIG. 9 A top view partly in section showing (A) a state where the first edge connector is fitted with the first card edge in an inverted state and (B) a state where the second edge connector is fitted with the second card edge in an inverted state

FIG. 10 A perspective view showing (A) a first edge connector, (B) a second edge connector, (C) a first card edge, and (D) a second card edge that are included in a connector assembly according to a second embodiment of the present invention

FIG. 11 A perspective view partly in section showing (A) a state where the first edge connector is fully fitted with the first card edge and (B) a state where the second edge connector is fully fitted with the second card edge

FIG. 12 A top view showing (A) a state where the second edge connector is fitted with the first card edge and (B) a top view partly in section showing an interior of a card edge insertion hole

FIG. 13 A sectional view taken along line XIII-XIII of FIG. 12

FIG. 14 A perspective view of (A) a first modification of the first card edge and the second card edge from those of the first embodiment and (B) a second modification of the first card edge and the second card edge from those of the first embodiment

FIG. 15 A view of a connector assembly according to another modified embodiment of the present invention which is modified from the first embodiment, and

FIG. 16 A view of a connector assembly according to yet another modified embodiment of the present invention which is modified from the second embodiment

### DESCRIPTION OF THE PREFERRED EMBODIMENT(S)

A connector set and a connector assembly according to a first embodiment of the present invention will be described in the following with reference to the appended drawings.

### First Embodiment

The connector assembly 1 of the first embodiment includes a card edge set 5 formed by end parts of circuit boards (hereinafter referred to as card edges 3), and a connector set 9 formed by card edge connectors (hereinafter referred to as edge connectors 7) configured to be fitted with the card edges 3, respectively.

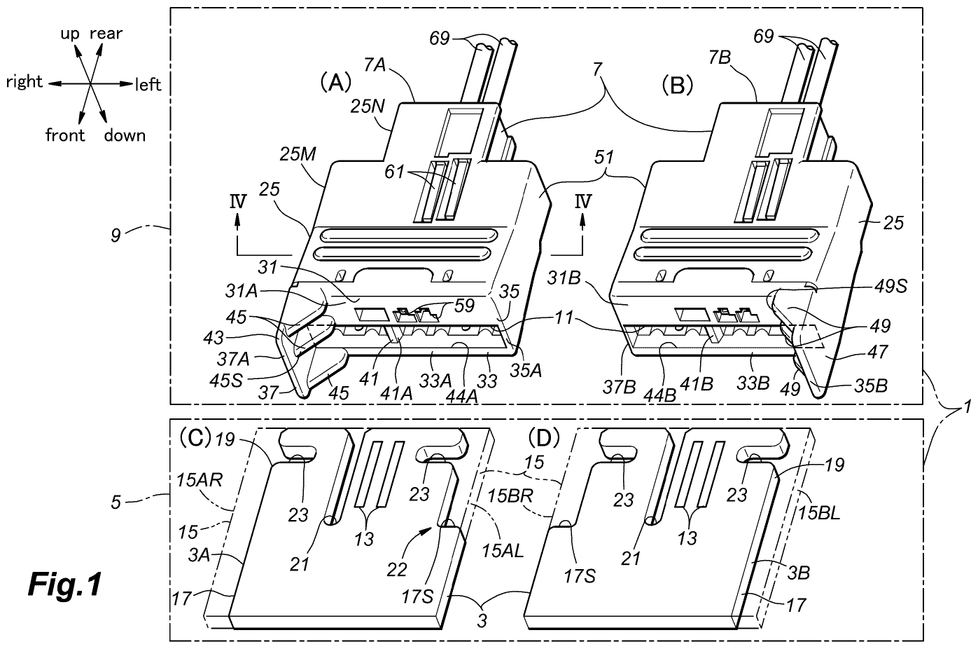

In this embodiment, as shown in (A) and (B) of FIG. 1, the connector set 9 includes two edge connectors 7 (also referred to as card edge connectors). Hereinafter, the edge connector 7 shown in (A) of FIG. 1 will be referred to as a first edge connector 7A (also referred to as a first card edge connector), and the edge connector 7 shown in (B) of FIG. 1 will be referred to as a second edge connector 7B (also referred to as a second card edge connector). The first edge connector 7A and the second edge connector 7B each have a card edge insertion hole 11 of the same shape for receiving the corresponding card edge 3.

As shown in (C) and (D) of FIG. 1, the card edge set 5 includes two card edges 3. The card edges 3 are configured to be fitted with the corresponding edge connectors 7 by being inserted into the card edge insertion holes 11 thereof. Hereinafter, the card edge 3 that fits into the first edge connector 7A will be referred to as the first card edge 3A (see (C) of FIG. 1), and the card edge 3 that fits into the second edge connector 7B will be referred to as the second card edge 3B. (See (D) of FIG. 1).

The first card edge 3A and the second card edge 3B each constitute a rear edge part (edge portion) of a circuit board, as shown in (C) and (D) of FIG. 1. The circuit board is a plate-shaped board, and may consist of a so-called PCB (printed circuit board). Metal pads 13 are provided on the surfaces (front surfaces) of the first card edge 3A and the second card edge 3B. In this embodiment, two pads 13 are provided on each of the first card edge 3A and the second card edge 3B, and each pad 13 has a rectangular shape elongated in the front-rear direction. The first card edge 3A and the second card edge 3B may be provided on separate circuit boards, or alternatively the first card edge 3A and the second card edge 3B may be provided on a same circuit board.

In the following description, the direction in which the card edge 3 is inserted into the edge connector 7 (also referred to as the insertion direction) is referred to as a rearward direction, and the direction in which the front surface (front surface) of the card edge 3 faces is referred to as an upward direction. In the following description, for example, the reverse insertion direction may be referred to as a forward direction. However, this definition of direction is only for the convenience of explanation and is not limited thereto.

As shown in (C) and (D) of FIG. 1, the first card edge 3A and the second card edge 3B each include a pair of cutouts 15 cut forward from the rear edge thereof along either side. Each of the cutouts 15 has a substantially rectangular shape extending forward from the rear edge. On account of these cutouts 15, the first card edge 3A and the second card edge 3B each include a substantially rectangular card edge base part 17 constituting a front part thereof, and a card edge extension part 19 extending rearward from the corresponding side of the card edge base part 17. Hereinafter, the part of the rear facing surface of the card edge base part 17 that is not connected to the card edge extension part 19 will be referred to as an abutting end surface 17S. Each abutting end surface 17S defines the rear facing surface of the corresponding cutout 15. A stepped portion 22 is thus formed at the rear of the card edge 3 by the card edge base part 17 and the card edge extension part 19.

In the following description, of the cutouts 15 (also referred to as the first cutouts) of the first card edge 3A, the left cutout 15 and the right cutout 15 are respectively referred to as a first left cutout 15AL and a first right cutout 15AR. In addition, of the cutouts 15 (also referred to as second cutouts) of the second card edge 3B, the left cutout 15 and the right cutout 15 are respectively referred to as a second left cutout 15BL and a second right cutout 15BR.

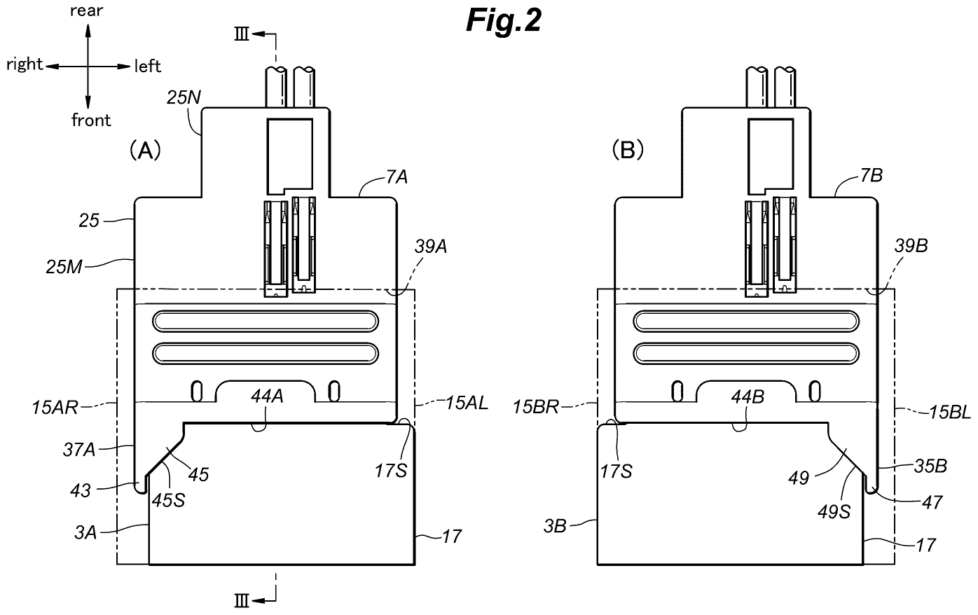

As shown in (C) and (D) of FIG. 1, and FIG. 2, the length of the first right cutout 15AR is longer than the length of the first left cutout 15AL. The length of the second left cutout 15BL is longer than the length of the second right cutout 15BR. The cutout length of the first right cutout 15AR and the cutout length of the second left cutout 15BL are approximately equal to each other, and the cutout length of the first left cutout 15AL and the cutout length of the second right cutout 15BR are approximately equal to each other.

Each card edge extension part 19 is provided with a slot 21 extending forward from the rear edge thereof. Each slot 21 is provided at a position slightly offset from the laterally central part of the card edge extension part 19. In this embodiment, the card edge extension part 19 of the first card edge 3A and the card edge extension part 19 of the second card edge 3B have the same shape. In this embodiment, each card edge extension part 19 is further provided with auxiliary slots 23 extending laterally inward from either side edge.

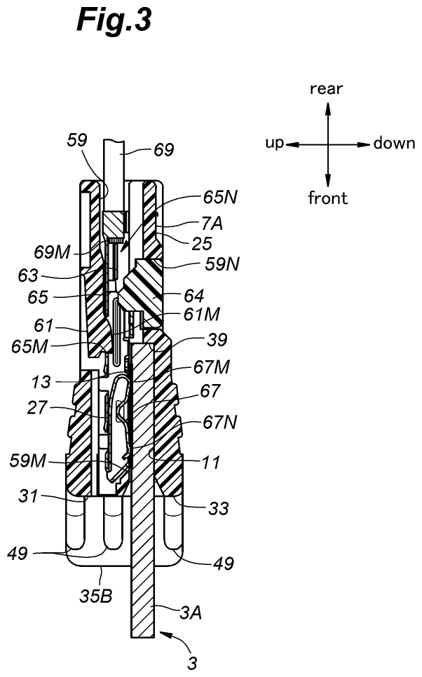

As shown in FIG. 3, the first edge connector 7A and the second edge connector 7B each include a housing 25 and a plurality of terminal members 27 received in and supported by the housing 25.

Each housing 25 is made of an insulating resin material. As shown in (A) and (B) of FIG. 1, each housing 25 includes a rectangular parallelepiped main body 25M extending laterally and a rectangular parallelepiped protrusion 25N projecting rearward from the main body 25M.

The card edge insertion hole 11 is provided in the lower front half of the main body 25M and is recessed toward the rear. The card edge insertion hole 11 of the first edge connector 7A and the card edge insertion hole 11 of the second edge connector 7B have the same shape.

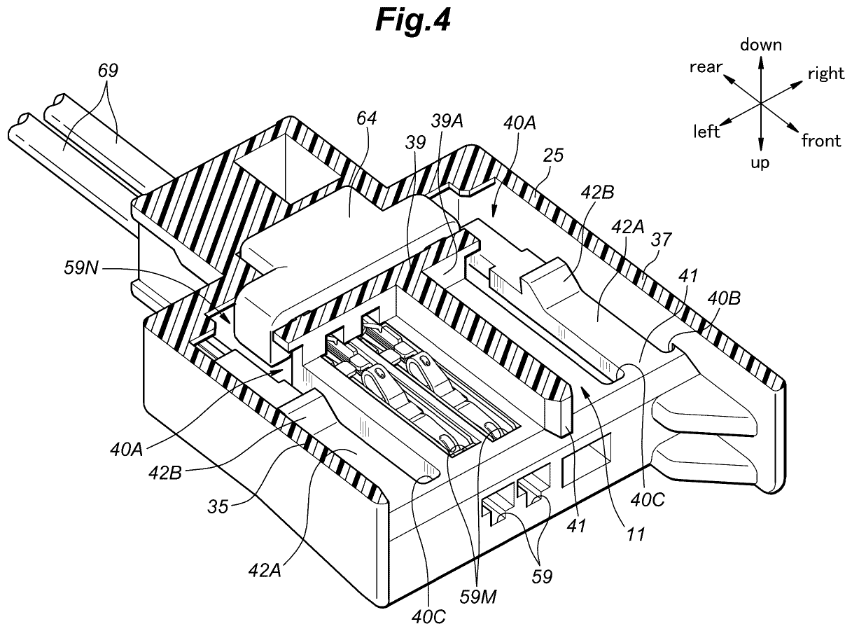

The card edge insertion hole 11 is defined by an upper wall 31, a lower wall 33, a left wall 35, a right wall 37, a rear wall 39, and a partition wall 41, as shown in FIGS. 1 and 4.

As shown in FIG. 1, the upper wall 31 defines the upper surface of the card edge insertion hole 11, or a boundary of the front side of the circuit board inserted into the card edge insertion hole 11. The lower wall 33 defines the lower surface of the card edge insertion hole 11, or a boundary of the back side of the card edge 3 inserted into the card edge insertion hole 11. The left wall 35 defines the left side of the card edge insertion hole 11, or an outer left boundary of the left end surface of the card edge 3 inserted into the card edge insertion hole 11. The right wall 37 defines the right side of the card edge insertion hole 11, or an outer right boundary of the right end surface of the card edge 3 inserted into the card edge insertion hole 11.

As shown in FIG. 4, the rear wall 39 defines at least a part of the front surface of the card edge insertion hole 11, or a rear boundary of the card edge 3 inserted into the card edge insertion hole 11. The upper wall 31, the lower wall 33, the right wall 37, and the left wall 35 each have a front-facing edge surface at the front end thereof.

In this embodiment, as shown in FIG. 4, a gap 40A is formed between the rear wall 39 and the left wall 35 and between the rear wall 39 and the right wall 37. Furthermore, a slot 40B extending from the rear to the front is provided between a rear part of the upper wall 31 and a rear part of the left wall 35, and a similar slot 40B is provided between a rear part of the upper wall 31 and a rear part of the right wall 37. The lateral ends of the upper wall 31 are each provided with a slot 40C that extends forward from near the rear end, passes near the corresponding side edge of the rear wall 39, and extends further forward. By providing the slots 40B and 40C, a pair of cantilever-shaped locking pieces 42A supported at the front ends thereof are formed on the left and right edges of the upper wall 31, respectively. Each of the locking pieces 42A is provided with a locking claw 42B that projects downward. When the card edge 3 is completely inserted into the card edge insertion hole 11, the locking claws 42B are received by the corresponding auxiliary slots 23, and the card edge 3 is locked in the housing 25 (of the edge connector 7).

The partition wall 41 has a laterally facing major surface and extends in the front-rear direction. The partition wall 41 is connected to the upper wall 31 at the upper end thereof and to the lower wall 33 at the lower end thereof. In this embodiment, as shown in FIG. 4, the partition wall 41 is further connected to the rear wall 39 at the rear end thereof, but the partition wall 41 is not required to be connected to the rear wall 39. The partition wall 41 divides the card edge insertion hole 11 into two parts, left and right, and partitions the card edge insertion hole 11 into two parts. In this embodiment, the partition wall 41 is provided at a position slightly offset from the center to the right in the card edge insertion hole 11.

In both the first edge connector 7A and the second edge connector 7B, the front end of the partition wall 41 is located behind the front end of any of the upper wall 31, the lower wall 33, the left wall 35, and the right wall 37.

Hereinafter, for the convenience of explanation, the upper wall 31, lower wall 33, left wall 35, right wall 37, rear wall 39, and partition wall 41 of the first edge connector 7A may be referred to as the first upper wall 31A, first lower wall 33A, first left wall 35A, first right wall 37A, first rear wall 39A, and first partition wall 41A, respectively. Similarly, the upper wall 31, lower wall 33, left wall 35, right wall 37, rear wall 39, and partition wall 41 of the second edge connector 7B may be referred to as the second upper wall 31B, second lower wall 33B, the second left wall 35B, second right wall 37B, second rear wall 39B, and second partition wall 41B, respectively.

The front end of the first upper wall 31A and the front end of the first lower wall 33A are located at the same position in the front-rear direction. The second upper wall 31B and the second lower wall 33B have the same shape as the first upper wall 31A and the first lower wall 33A, respectively, so that the front end of the second upper wall 31B and the front end of the second lower wall 33B are also at the same position in the front-rear direction.

The first right wall 37A extends more forward than the first upper wall 31A and the first lower wall 33A. On the other hand, the front end (rear end with respect to the insertion direction) of the second right wall 37B is located at the same position in the front-rear direction as the front end of the second upper wall 31B and the front end of the second lower wall 33B. Thus, when the front end of the first upper wall 31A and the front end of the second upper wall 31B are aligned with each other in the front-rear direction (laterally lined up), the front end of the first right wall 37A differs from the position of the front end of the second right wall 37B such that the front end of the first right wall 37A is located more forward than the front end of the second right wall 37B.

In the first edge connector 7A, the opening edge 44A of the card edge insertion hole 11 is defined by the first upper wall 31A, the first left wall 35A, the first lower wall 33A, and the part (see (A) of FIG. 1) of the first right wall 37A that aligns with the front edges of the first upper wall 31A and the first lower wall 33A with respect to the front-rear direction.

In the second edge connector 7B, the opening edge 44B of the card edge insertion hole 11 is defined by the second upper wall 31B, the second right wall 37B, the second lower wall 33B, and the part (see (B) of FIG. 1) of the second left wall 35B that aligns with the front edges of the second upper wall 31B and the second lower wall 33B with respect to the front-rear direction.

The position of the front end of the first right wall 37A relative to the opening edge 44A is different from the position of the front end of the second right wall 37B relative to the opening edge 44A. More specifically, the position of the front end of the first right wall 37A relative to the opening edge 44A is located more forward than the second right wall 37B.

The front part of the first right wall 37A projecting beyond the first upper wall 31A and the first lower wall 33A (hereinafter referred to as the first protruding wall 43) is provided with ribs 45 extending in the front-rear direction on the left side surface thereof. The ribs 45 are connected at their rear ends to the first upper wall 31A or the first upper wall 31A. In this embodiment, the first right wall 37A includes two ribs 45 connected to the upper edge and lower edge of the first upper wall 31A, respectively, and another rib 45 connected to the first lower wall 33A.

The ribs 45 provided on the first protruding wall 43 are each configured such that the protrusion height, that is, the protrusion height in the lateral direction progressively increases toward the rear (main body portion 25M). As a result, the protruding end surface of each rib 45 forms an inclined surface 45S that is inclined toward the left as one moves toward the rear (toward the main body portion 25M).

The second left wall 35B extends more forward than the second upper wall 31B and the second lower wall 33B. On the other hand, the front end of the second right wall 37B is located at the same position in the front-rear direction as the front end of the first upper wall 31A and the front end of the first lower wall 33A. Therefore, when the front end of the first upper wall 31A and the front end of the second upper wall 31B are aligned to each other in the front-rear direction (laterally lined up), the position of the front end (rear end with respect to the insertion direction) of the second left wall 35B differs from the front end of the first left wall 35A with respect to the front-rear direction, and is positioned ahead of the front end of the first left wall 35A.

As shown in (A) and (B) of FIG. 2, the distance between the front end surface of the first right wall 37A and the first rear wall 39A is smaller than the cutout length of the first right cutout 15AR, and is greater than the cutout length of the second right cutout 15BR. The distance between the second rear wall 39B and the front end surface of the second left wall 35B is smaller than the cutout length of the second left cutout 15BL and greater than the cutout length of the first right cutout 15AR.

As shown in (B) of FIG. 1, the front part of the second left wall 35B which is ahead of the second upper wall 31B and the second lower wall 33B (hereinafter referred to as the second protruding wall 47) is provided with a plurality of ribs 49 extending in the front-rear direction on the right side surface thereof. The ribs 49 are connected at their rear ends to the second upper wall 31B or the second lower wall 33B. In this embodiment, the second left wall 35B is provided with two ribs 49 connected to the upper edge and lower edge of the second upper wall 31B, respectively, and another rib 49 connected to the second lower wall 33B.

The ribs 49 provided on the second protruding wall 47 are each configured such that the protruding height thereof increases toward the rear (main body portion 25M). As a result, the protruding end surface of the rib 49 forms an inclined surface 49S that is inclined rightward as one moves toward the rear (toward the main body portion 25M).

In this embodiment, as shown in (A) and (B) of FIG. 1, the part of the first edge connector 7A excluding the first protruding wall 43 and the ribs 45 provided on the first protruding wall 43 (connector main body 51) has the same configuration as the part of the second edge connector 7B excluding the second protruding wall 47 and the ribs 49 provided on the second protruding wall 47. In other words, one can say that the first edge connector 7A consists of the connector main body 51, the first protruding wall 43, and the first protruding walls 43, and the second edge connector 7B consists of the connector main body 51, the second protruding wall 47, and the second protruding walls 47.

A plurality of (two in this embodiment) terminal insertion holes 59 are provided on the rear surface of the housing 25. As shown in FIG. 3, the terminal insertion holes 59 open at the rear surface of the protrusion 25N and extend toward the front. The terminal insertion holes 59 are arranged laterally next to each other. In this embodiment, the terminal insertion holes 59 extend from an upper half part of the rear surface of the protrusion 25N to the front end of the upper wall 31, and open at the front surface of the upper wall 31.

Each terminal insertion hole 59 is provided with a communication hole 59M that communicates with the card edge insertion hole 11. The communication hole 59M is preferably provided in a front part of the terminal insertion hole 59.

The wall defining the upper edge of each terminal insertion hole 59 is provided with a lance piece 61 for locking the terminal member 27 in the terminal insertion hole 59. The lance piece 61 has a cantilever shape extending forward from the upper rear end of the housing 25. The free end of the lance piece 61 is provided with a locking projection 61M that projects downward.

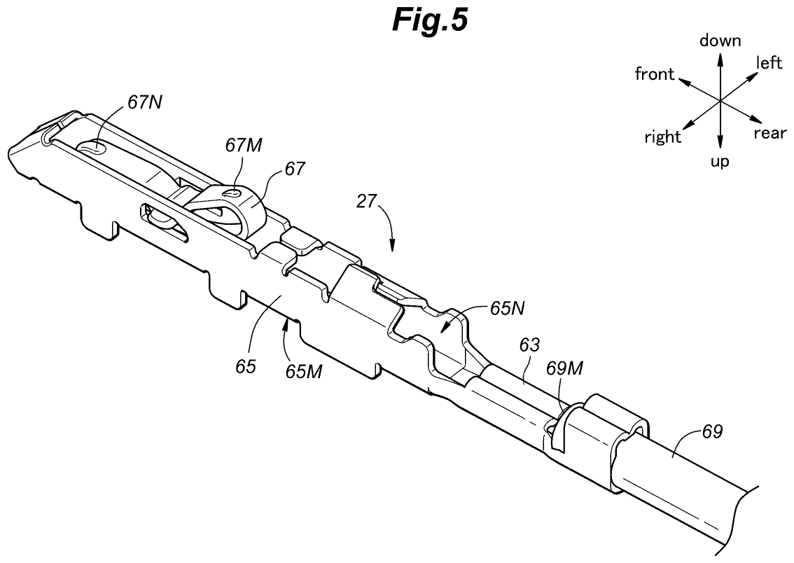

Each terminal member 27 consists of a sheet metal member formed by bending a piece of stamp formed sheet metal. As shown in FIG. 5, the terminal member 27 includes a crimp portion 63, a housing 65 provided in front of the crimp portion 63, and a spring piece 67 supported by the housing 65.

The crimp portion 63 has a cylindrical shape extending in the front-rear direction. A conductor 69M, which is a core wire of the cable 69, is inserted into the inner bore of the crimp portion 63 and is crimped therein. Thereby, the terminal member 27 is electrically connected to the conductor 69M.

The housing 65 has a channel cross-sectional shape that is open downward. As shown in FIG. 3, the housing 65 is provided with a locking hole 65M that penetrates in the vertical direction. The terminal member 27 is secured to the housing 25 by the locking projection 61M of the lance piece 61 being received in the locking hole 65M.

In this embodiment, the lower surface of the housing 65 is provided with an opening 65N that penetrates in the vertical direction. The lower wall 33 that defines the lower surface of the terminal insertion hole 59A is provided with a retainer insertion hole 59N communicating with the terminal insertion hole 59. A resin retainer 64 is inserted into the retainer insertion hole 59N. The retainer 64 is supported by the housing 25 by being inserted into the retainer insertion hole 59N. The upper end of the retainer 64 projects into the opening 65N and locks the terminal member 27 to the housing 25.

As shown in FIG. 5, a spring piece 67 is housed in the housing 65. The spring piece 67 is connected to the housing 65 at the base end thereof. A pressing portion 67M and a contact portion 67N that protrude downward are provided on the lower surface of the spring piece 67. The pressing portion 67M and the contact portion 67N are formed as embossed portions of the spring piece 67 that protrude downward. The pressing portion 67M is located behind the contact portion 67N.

As shown in FIG. 3, the terminal members 27 are received in the corresponding terminal insertion holes 59. Each spring piece 67 projects into the card edge insertion hole 11 via the communication hole 59M. When the card edge 3 is not inserted into the card edge insertion hole 11, the pressing portions 67M are located inside the card edge insertion hole 11.

Next, the effects of the connector assembly 1 and connector set 9 configured as described above will be discussed in the following.

As shown in (A) of FIG. 2, when the first edge connector 7A is completely fitted with the first card edge 3A, the card edge extension part 19 of the first card edge 3A touches the first rear wall 39A and is completely received in the card edge insertion hole 11 of the first edge connector 7A.

The distance between the front end surface of the first right wall 37A and the first rear wall 39A is smaller than the cutout length of the first right cutout 15AR. Therefore, when the first right wall 37A is received inside the first right cutout 15AR, the first right wall 37A extends along the right edge of the card edge extension part 19 of the first card edge 3A. The first partition wall 41A is received in the slot 21.

When the first card edge 3A is inserted into the card edge insertion hole 11 of the first edge connector 7A, the first card edge 3A contacts the pressing portion 67M, which then moves toward the bottom wall of the housing 65. As a result, the contact portions 67N moves toward the card edge insertion hole 11. When the first edge connector 7A is completely fitted with the first card edge 3A, the contact portions 67N are in contact with the corresponding pads 13 of the first card edge 3A as shown in FIG. 3.

As shown in (B) of FIG. 2, when the second edge connector 7B is completely fitted with the second card edge 3B, the card edge extension part 19 of the second card edge 3B touches the second rear wall 39B and is completely received in the card edge insertion hole 11 of the second edge connector 7B.

The distance between the front end surface of the second left wall 35B and the second rear wall 39B is smaller than the length of the second left cutout 15BL. Therefore, the second left wall 35B is received inside the second left cutout 15BL, and the second left wall 35B extends along the left edge of the card edge extension part 19 of the second card edge 3B. The second partition wall 41B is received in the slot 21.

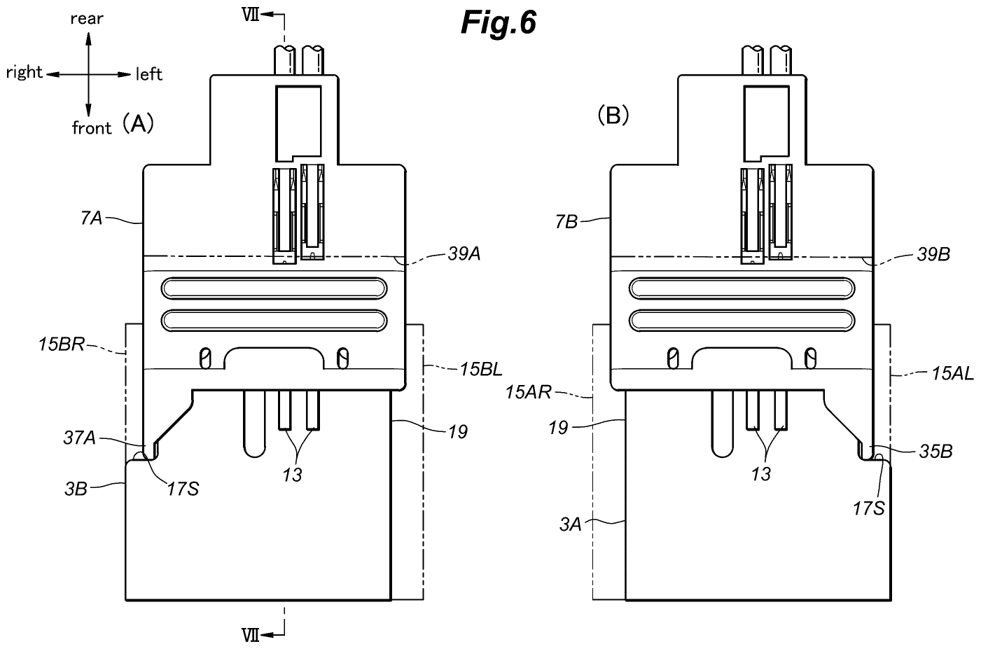

The front end surface of the first right wall 37A is located more forward than the front end surface of the second right wall 37B with respect to the opening edge 44A, and the card edge insertion hole 11 of the first edge connector 7A and the card edge insertion hole 11 of the second edge connector 7B have the same shape. The distance between the front end surface of the first right wall 37A and the first rear wall 39A is greater than the distance between the front end surface of the second right wall 37B and the second rear wall 39B, and is greater than the cutout length of the second right cutout 15BR. Therefore, as shown in (A) of FIG. 6, when the operator attempts to insert the second card edge 3B into the first edge connector 7A, the front end surface of the first right wall 37A abuts against the abutting end surface 17S so that the second card edge 3B cannot be inserted into the first edge connector 7A deep enough for the card edge extension part 19 of the second card edge 3B to come into contact with the first rear wall 39A. Therefore, it is possible to prevent incorrect fitting between the first edge connector 7A and the second card edge 3B which do not correspond to each other. In other words, the first right wall 37A cooperates with the second right cutout 15BR so as to function as an incorrect insertion preventing wall that prevents incorrect insertion.

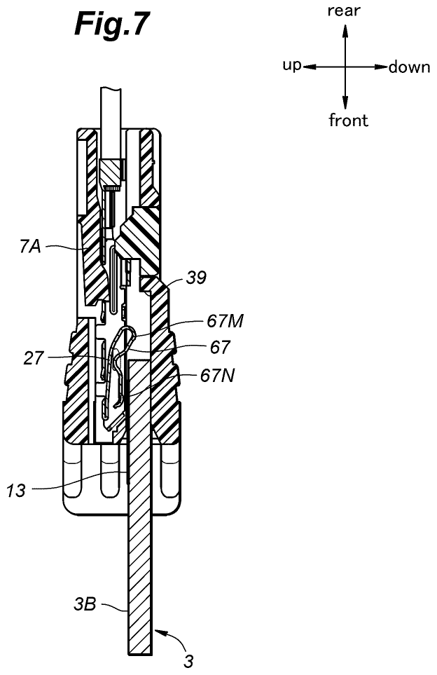

In this embodiment, each terminal member 27 is configured so as not to come into contact with the pad 13 of the second card edge 3B since the second card edge 3B cannot be inserted into the first edge connector 7A deep enough for the card edge extension part 19 of the second card edge 3B to come into contact with the first rear wall 39A. Therefore, in such a situation, as shown in FIG. 7, the terminal member 27 of the first edge connector 7A and the pad 13 of the second card edge 3B cannot be electrically connected.

By forming the cutout 15 that does not accept the incorrect insertion preventing wall (first right wall 37A) of the first edge connector 7A but accepts the wall (second right wall 37B) of the second edge connector 7B corresponding to the incorrect insertion preventing wall in this way, the second card edge 3B cannot be inserted into the first edge connector 7A. Therefore, the connector set 9 including the first edge connector 7A and the second edge connector 7B can prevent incorrect fitting.

Similarly, as shown in (B) of FIG. 6, when the operator attempts to insert the first card edge 3A into the second edge connector 7B, the second card edge 3B cannot be inserted into the first edge connector 7A deep enough for the front end surface of the second left wall 35B to come into contact with the abutting end surface 17S and the card edge extension part 19 of the first card edge 3A to come into contact with the first rear wall 39A. Thereby, incorrect fitting between the second edge connector 7B and the first card edge 3A which do not correspond to each other can be avoided. In other words, the second left wall 35B cooperates with the first left cutout 15AL to function as an incorrect insertion preventing wall that prevents incorrect insertion.

Since the incorrect insertion preventing wall is constructed by changing the position and extension length of the end of the first right wall 37A or the second left wall 35B, the structure can be simplified. Further, since the first right wall 37A and the second left wall 35B each protrude forward from the edge of the corresponding card edge insertion hole 11, the operator can easily visually distinguish between the first edge connector 7A and the second edge connector 7B.

As shown in (A) and (B) of FIG. 1, the ribs 45 and 49 are provided at the front of the first right wall 37A and the front of the second left wall 35B, respectively. Thereby, the rigidity of the front part of the first right wall 37A and the second left wall 35B, which protrude forward from the opening edges 44A and 44B of the card edge insertion hole 11, can be increased.

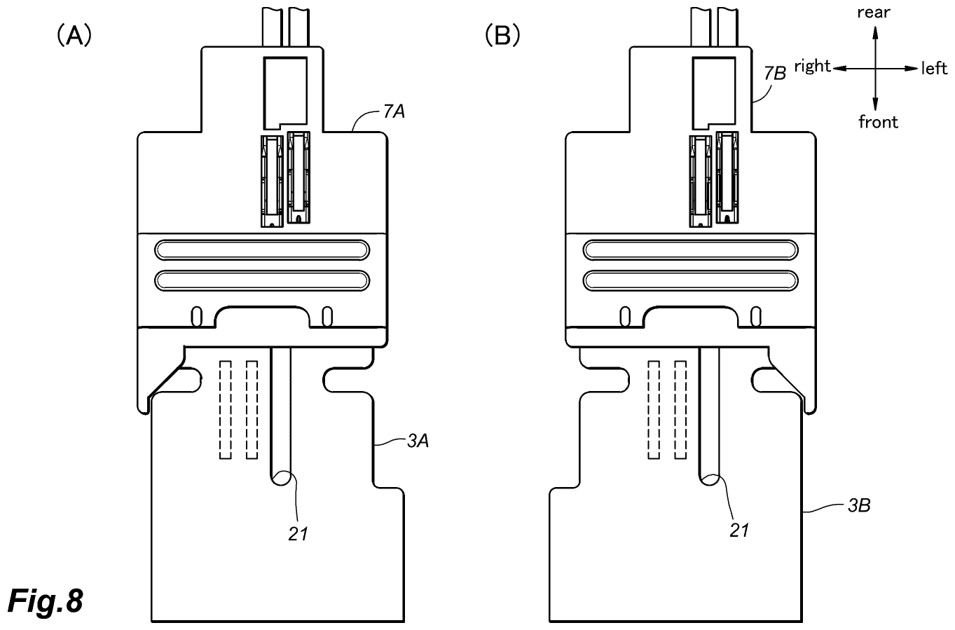

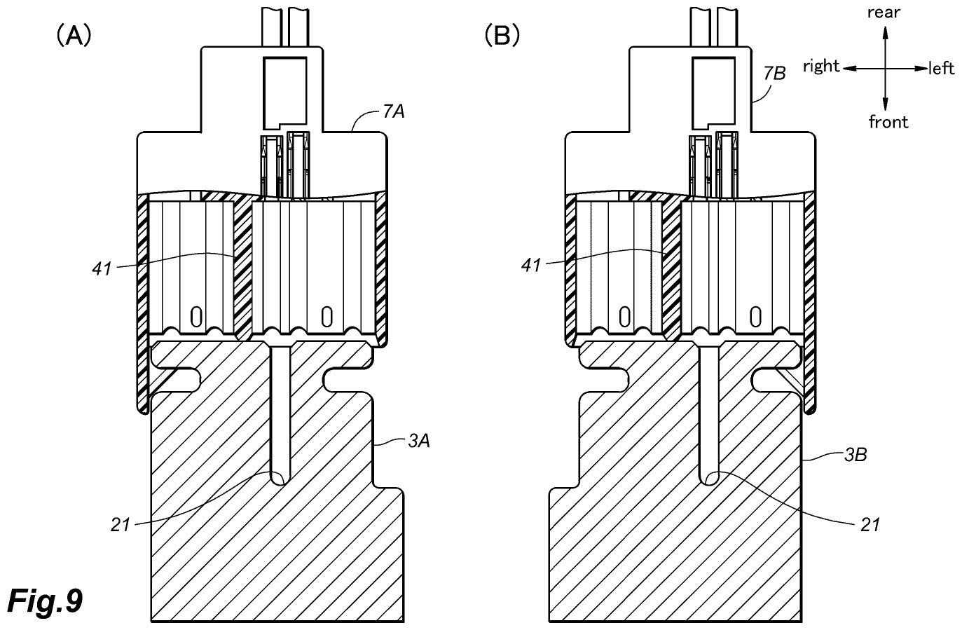

The partition wall 41 is provided at a position offset from the center to the right side in the card edge insertion hole 11, and the slot 21 is provided at a position similarly offset to the right in the card edge extension part 19 in a corresponding manner. Therefore, as shown in (A) of FIG. 8, when an attempt is made to insert the first card edge 3A into the first edge connector 7A in a vertically inverted orientation, the partition wall 41 abuts against the rear end of the first card edge 3A and cannot be inserted into the slot 21 as shown in (A) of FIG. 9. Therefore, the first card edge 3A cannot be inserted into the first edge connector 7A. Moreover, as shown in (B) of FIG. 8, when an attempt is made to insert the second card edge 3B into the second edge connector 7B in a vertically inverted orientation, the partition wall 41 abuts against the rear end of the second card edge 3B so that the partition wall 41 cannot be inserted into the slot 21 shown in (B) of FIG. 9. Therefore, the second card edge 3B cannot be inserted into the second edge connector 7B. In this manner, by providing the partition wall 41 at a position offset to either the left or right side in the card edge insertion hole 11, it is possible to prevent incorrect insertion of the card edge 3 in an inverted orientation.

### Second Embodiment

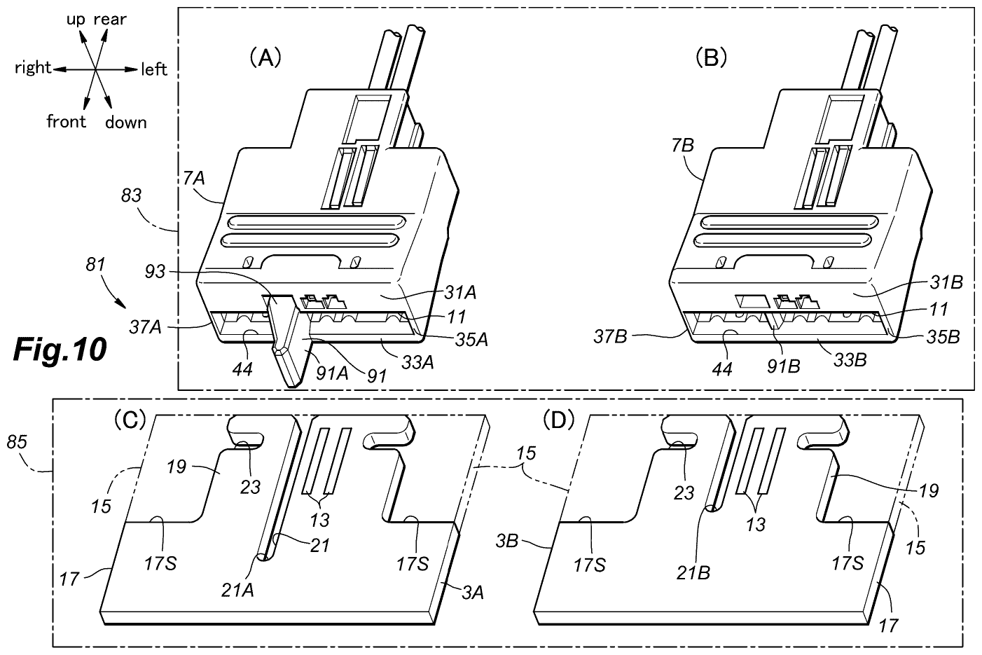

Similarly to the first embodiment, a connector assembly 81 according to the second embodiment of the present invention includes a connector set 83 including a first edge connector 7A and a second edge connector 7B, and a card edge set 85 including a first card edge 3A and a second card edge 3B. However, as shown in (A) to (D) of FIG. 10, the left wall 35, the right wall 37, and the partition wall 91 of the housing 25 of each of the first edge connector 7A and the second edge connector 7B differ from those of the first embodiment. Furthermore, the lengths of the cutouts 15 and slots 21 of the first card edge 3A and the second card edge 3B are different from those of the first embodiment. The second embodiment is otherwise similar to the first embodiment. Therefore, description of other parts will be omitted.

The front end of the first right wall 37A, the front end of the first left wall 35A, the front end of the first upper wall 31A, and the front end of the first lower wall 33A of the first edge connector 7A of the second embodiment are aligned to one another in the front-rear direction. The opening edge 44 of the card edge insertion hole 11 of the first edge connector 7A is defined by the front end of the first right wall 37A, the front end of the first left wall 35A, the front end of the first upper wall 31A, and the front end of the first lower wall 33A.

The front end of the second right wall 37B, the front end of the second left wall 35B, the front end of the second upper wall 31B, and the front end of the second lower wall 33B of the second edge connector 7B are aligned with one another in the front-back direction. The opening edge 44 of the card edge insertion hole 11 of the second edge connector 7B is defined by the front end of the second right wall 37B, the front end of the second left wall 35B, the front end of the second upper wall 31B, and the front end of the second lower wall 33B.

The front end surface of the first partition wall 91A is located more forward than the front end of the first right wall 37A, the front end of the first left wall 35A, the front end of the first upper wall 31A, and the front end of the first lower wall 33A. In other words, the front end surface of the first partition wall 91A is located ahead of the opening edge 44 of the card edge insertion hole 11.

On the other hand, the front end surface of the second partition wall 91B is located more rearward than the front end of the second right wall 37B, the front end of the second left wall 35B, the front end of the second upper wall 31B, and the front end of the second lower wall 33B. In other words, the front end surface of the second partition wall 91B is located behind the opening edge 44 of the card edge insertion hole 11.

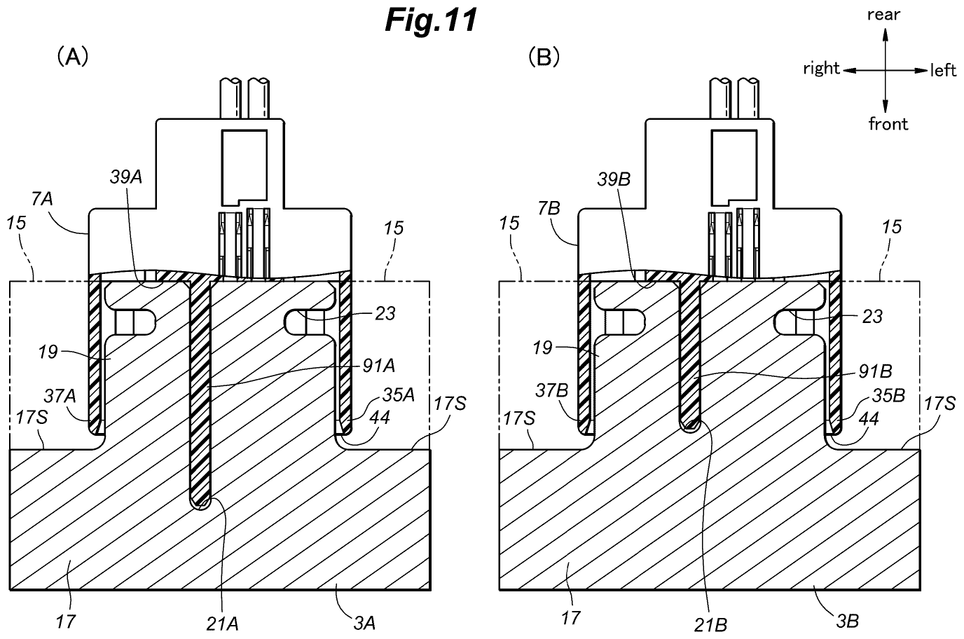

Thus, when the front end of the first upper wall 31A and the front end of the second upper wall 31B are aligned with each other with respect to the front-rear direction (laterally aligned with other), the front end of the first partition wall 91A (the rear end with respect to the insertion direction) is positioned differently from the position of the front end of the second partition wall 91B, and located more forward than the front end of the first partition wall 91A. As shown in (A) and (B) of FIG. 11, the distance between the front end of the first partition wall 91A and the first rear wall 39A is greater than the distance between the front end of the second partition wall 91B and the second rear wall 39B. Further, the position of the front end surface of the first partition wall 91A with respect to the opening edge 44 is different from that of the second partition wall 91B.

The card edge insertion hole 11 provided in the first edge connector 7A and the card edge insertion hole 11 provided in the second edge connector 7B are similar to each other except for the difference in shape between the first partition wall 91A and the second partition wall 91B.

As shown in (A) of FIG. 10, the front part of the first partition wall 91 located ahead of the first upper wall 31A and the first lower wall 33A is provided with a plurality of ribs 93 extending in the front-rear direction. The ribs 93 extend rearward from near the front edge of the first partition wall 91A, and are connected to the first upper wall 31A or the first lower wall 33A at the rear ends thereof. In this embodiment, the ribs 93 of the first partition wall 91 consist of two ribs 93 that are connected to the lower edge of the first upper wall 31A and the first lower wall 33A, respectively. By providing the ribs 93, the rigidity of the front part of the first partition wall 91A is increased. In this embodiment, the height (the amount of protrusion in the rightward direction) of each rib 93 protruding from the first partition wall 91A increases toward the rear.

The first card edge 3A and the second card edge 3B each include a card edge base part 17 and a card edge extension part 19, similarly to the first embodiment. A pair of cutouts 15 are provided on either side of the rear end part of each of the first card edge 3A and the second card edge 3B. As a result, in each of the first card edge 3A and the second card edge 3B, the card edge extension part 19 extends rearward from a laterally central part of the rear edge of the card edge base part 17. The cutouts 15 have substantially the same shape, and the length of each cutout 15 is greater than any of the distance between the front end of the first right wall 37A and the first rear wall 39A, the distance between the front end of the first left wall 35A and the first rear wall 39A, the distance between the front end of the second right wall 37B and the second rear wall 39B, and the distance between the front end of the second left wall 35B and the second rear wall 39B.

The slot 21 of the first card edge 3A (hereinafter referred to as the first slot 21A) and the slot 21 of the second card edge 3B (hereinafter referred to as the second slot 21B) extend forward from the rear edge of the card edge extension part 19.

The cutout length of the first slot 21A is greater than the distance between the front end surface of the first partition wall 91A and the first rear wall 39A, and the distance between the front end surface of the second partition wall 91B and the second rear wall 39B, and the cutout length of the second slot 21B. The first slot 21A extends more forward than the rear end surface of the card edge extension part 19 and reaches the card edge base part 17.

The cutout length of the second slot 21B is smaller than the distance between the front end surface of the first partition wall 91A and the first rear wall 39A, and the cutout length of the first slot 21A, and is longer than the distance between the front end surface of 91B and the second rear wall 39B. The rear end of the second slot 21B does not reach the card edge base part 17.

Next, the effects of the connector assembly 81 and the connector set 83 according of the second embodiment will be discussed in the following.

When the first edge connector 7A is completely fitted with the first card edge 3A, the card edge extension part 19 of the first card edge 3A touches the first rear wall 39A and is completely received in the card edge insertion hole 11 of the first edge connector 7A as shown in (A) of FIG. 11. At this time, the terminal members 27 are in contact with the corresponding pads 13.

The cutout length of the first slot 21A is greater than the distance between the front end surface of the first partition wall 91A and the first rear wall 39A. Therefore, the first partition wall 91A is received in the first slot 21A. Further, since the length of the cutout 15 is longer than the distance between the front end of the first right wall 37A and the first rear wall 39A and the distance between the front end of the first left wall 35A and the first rear wall 39A, the first right wall 37A and the first left wall 35A are each received in the respective cutouts 15. Therefore, when fully inserted, the first right wall 37A and the first left wall 35A may be separated from the rear end surface of the card edge base part 17 of the first card edge 3A as shown in (A) of FIG. 11, or alternatively may be in contact with the rear end surface of the card edge base part 17 of the first card edge 3A.

When the second edge connector 7B is completely fitted with the second card edge 3B, the card edge extension part 19 of the second card edge 3B touches the second rear wall 39B and is completely received in the card edge insertion hole 11 of the second edge connector 7B as shown in (B) of FIG. 11. At this time, the terminal members 27 are in contact with the corresponding pads 13.

The cutout length of the second slot 21B is greater than the distance between the front end surface of the second partition wall 91B and the second rear wall 39B. Therefore, the second partition wall 91B is received in the second slot 21B. Further, the length of the cutout 15 is greater than the distance between the front end of the second right wall 37B and the second rear wall 39B and the distance between the front end of the second left wall 35B and the second rear wall 39B so that the second right wall 37B and the second left wall 35B are received in the respective cutouts 15. Therefore, as shown in (B) of FIG. 11, when fully inserted, the second right wall 37B and the second left wall 35B may be separated from the rear end surface of the card edge base part 17 of the second card edge 3B or alternatively may be in contact with the rear end surface of the card edge base part 17 of the second card edge 3B.

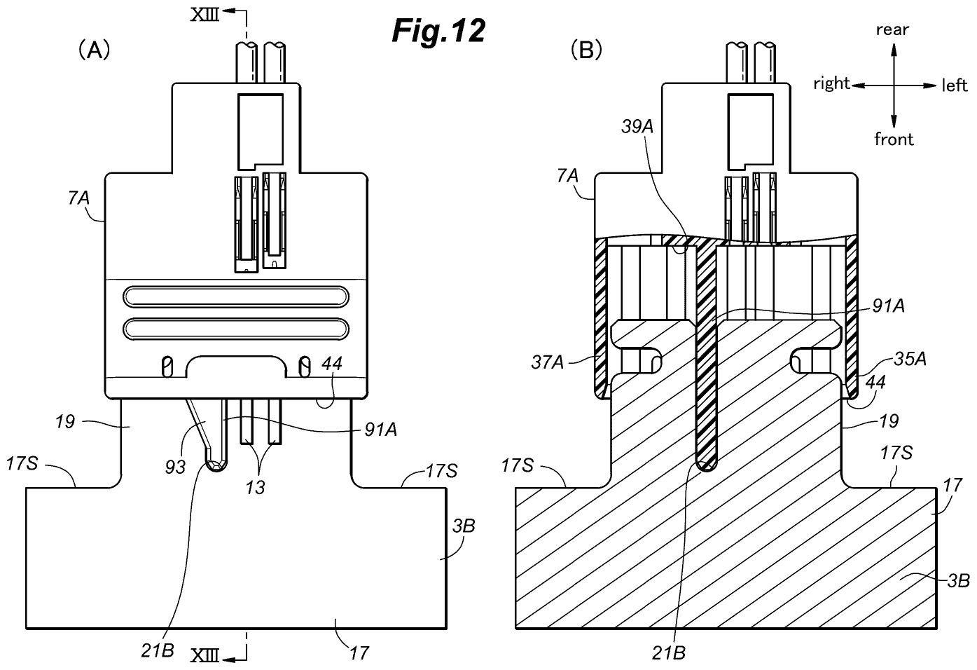

The position of the front end surface of the first partition wall 91A with respect to the opening edge 44 is located more forward than the front end surface of the second partition wall 91B, and the card edge insertion hole 11 of the first edge connector 7A has the same shape as the card edge insertion hole 11 of the second edge connector 7B. The distance between the front end surface of the first partition wall 91A and the first rear wall 39A is greater than the cutout length of the second slot 21B. Therefore, as shown in (A) and (B) of FIG. 12, when an attempt is made to insert the second card edge 3B into the first edge connector 7A, the operator is not able to insert the second card edge 3B into the first edge connector 7A deep enough for the card edge extension part 19 of the second card edge 3B to come into contact with the first rear wall 39A because the front end surface of the first partition wall 91A abuts against the wall surface defining the second slot 21B. Therefore, it is possible to prevent incorrect insertion between the first edge connector 7A and the second card edge 3B, which do not correspond to each other. In other words, the first partition wall 91A cooperates with the second slot 21B so as to function as an incorrect insertion preventing wall that prevents the first edge connector 7A and the second card edge 3B from fitting with each other.

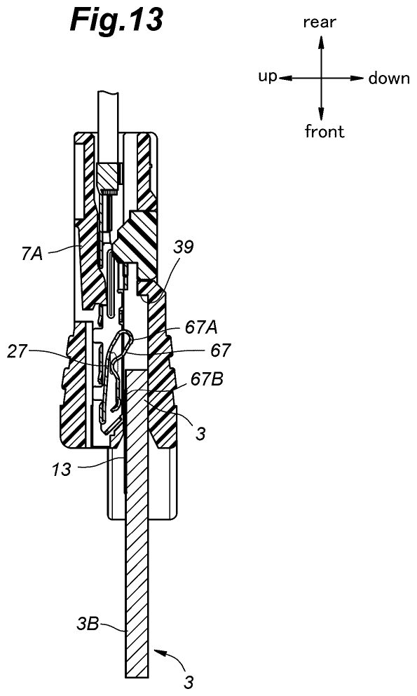

When the second card edge 3B is inserted into the first edge connector 7A until the front end surface of the first partition wall 91A comes into contact with the wall defining the second slot 21B, the terminal members 27 do not contact the corresponding pads 13 as shown in FIG. 13. Therefore, even if the second card edge 3B is inserted into the first edge connector 7A, conductive connection between the terminal members 27 of the first edge connector 7A and the corresponding pads 13 of the second card edge 3B can be prevented. In this way, by causing the position of the front end surface of the first partition wall 91A relative to the first rear wall 39A (that is, the position of the front end surface of the first partition wall 91A relative to the opening edge 44) to differ from the position of the front end surface of the second partition wall 91B relative to the second rear wall 39B (that is, the position of the front end surface of the second partition wall 91B relative to the opening edge 44), an incorrect insertion preventing wall can be easily formed and incorrect insertion can be prevented.

In the second embodiment also, the partition wall 91 is provided at a position offset from the center to the right side in the card edge insertion hole 11, and the slot 21 is also provided at a position offset to the right side in the card edge extension part 19 in a corresponding manner. In this way, by providing the partition wall 91 at a position offset to either the left or right side in the card edge insertion hole 11, it is possible to prevent incorrect insertion of the card edge 3 due to the inversion of the card edge connector 7, similarly as in the first embodiment.

The present invention has been described in terms of specific embodiments thereof, but is not limited to the above embodiments and modifications, and can be implemented in a wide range of modifications.

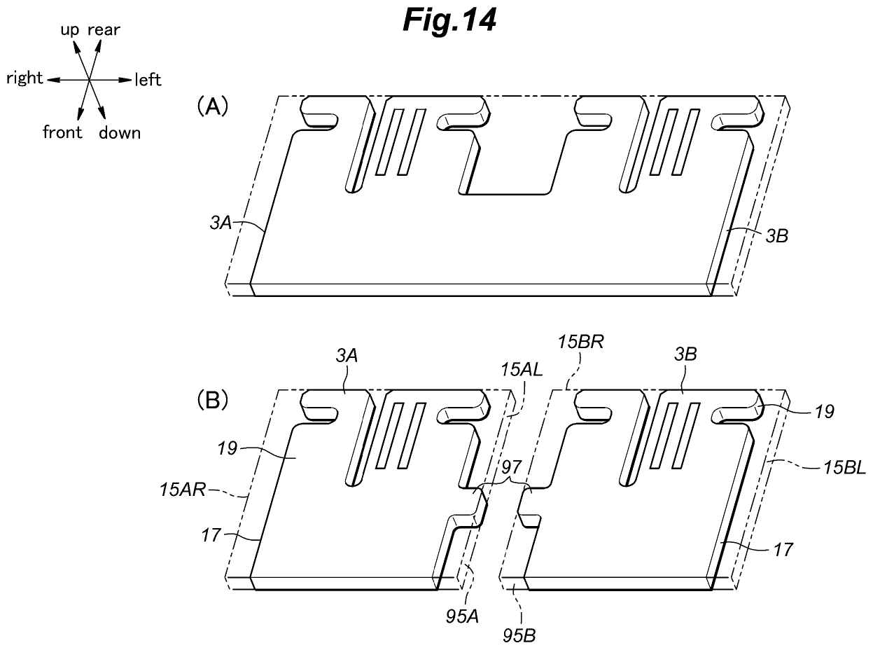

In the first and second embodiments described above, as shown in FIGS. 1 and 10, respectively, the first card edge 3A and the second card edge 3B are provided on separate circuit boards that are formed separately from each other, but the present invention is not limited to these embodiments. As shown in the first modification example of (A) of FIG. 14, the first card edge 3A and the second card edge 3B may be integrally connected to each other. Further, the first card edge 3A and the second card edge 3B may be integrally formed in a single circuit board.

Further, as shown in the second modified example of (B) of FIG. 14, in addition to the first left cutout 15AL and the first right cutout 15AR on the first card edge 3A, another cutout 95A may be provided at a certain distance ahead of the first left cutout 15AL on the first card edge 3A, and yet another cutout 95B may be provided at a certain distance ahead of the second right cutout 15BR on the second card edge 3B. Thereby, the first card edge 3A and the second card edge 3B may each include a protrusion 97 that projects outward from the left and right edges of the card edge base part 17, respectively.

The card edge set 5 may also include three or more card edges 3, and the connector set 9 may include three or more edge connectors 7 so as to correspond to the card edges 3.

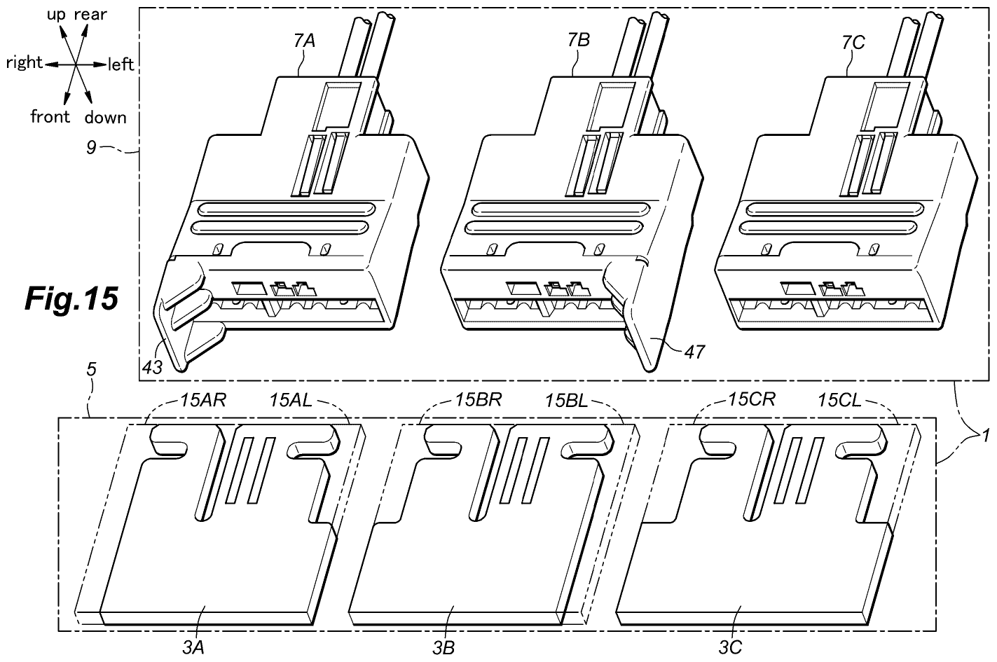

For example, the first embodiment may be modified such that the connector set 9 includes, in addition to the first edge connector 7A and the second edge connector 7B of the first embodiment, a third edge connector 7C not having a first protruding wall 43 or a second protruding wall 47 formed therein as shown in FIG. 15. The card edge set 5 in this case includes, in addition to the first card edge 3A and the second card edge 3B, a third card edge 3C having a third right cutout 15CR on the front right edge thereof and a third left cutout 15CL on the front left side edge thereof. The lengths of the third left cutout 15CL and the third right cutout 15CR are each set to be equal to the first left cutout 15AL. This prevents incorrect fitting of the first edge connector 7A with the second edge connector 7B and third edge connector 7C, and incorrect fitting of the second edge connector 7B to the first edge connector 7A and third edge connector 7C.

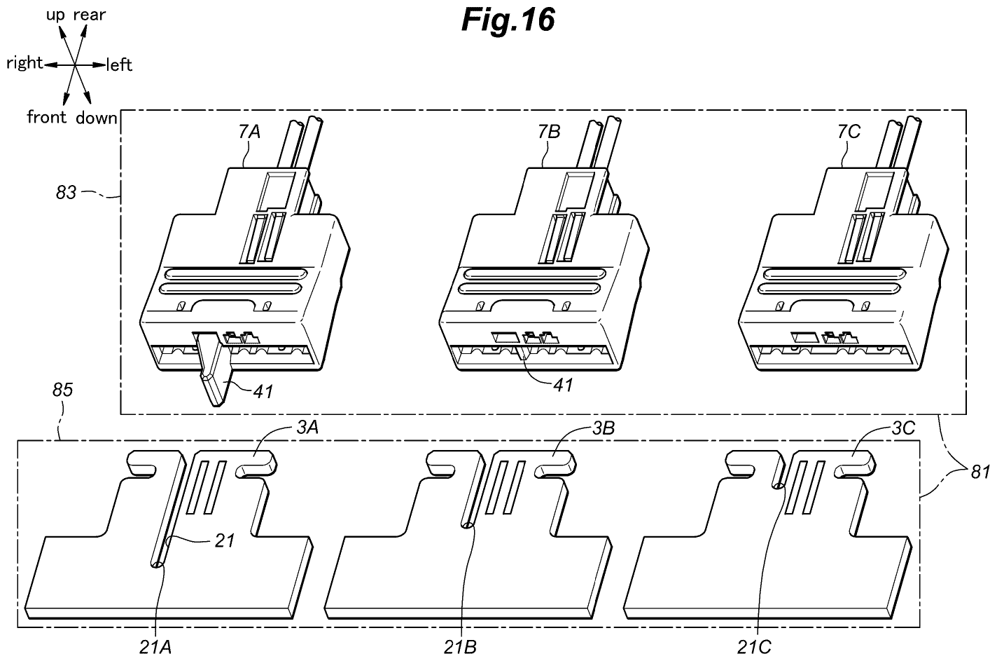

In addition, the second embodiment may be modified such that the connector set 83 includes, in addition to the first edge connector 7A and the second edge connector 7B of the second embodiment, a third edge connector 7C in which the distance between the front end position of the partition wall 41 and the rear wall 39 differs from those of the first edge connector 7A and the second edge connector 7B as shown in FIG. 16. In the example shown in FIG. 16, the distance between the front end of the partition wall 41 and the rear wall 39 is smaller in the case of the third edge connector 7C than in the case of the second edge connector 7B. In this case, the cutout length of the slot 21 (third slot 21C) of the third edge connector 7C is preferably shorter than the first slot 21A and the second slot 21B. This can prevent incorrect fitting of the first edge connector 7A with the second card edge 3B and with the third card edge 3C, and incorrect fitting of the second edge connector 7B with the third card edge 3C. In this way, by providing the incorrect insertion preventing wall, it is possible to prevent incorrect fitting of at least one combination of the card edge 3 and the edge connector 7 that does not correspond.

In the embodiments described above, when the edge connector 7 is completely fitted with the card edge 3, the card edge 3 is in contact with the rear wall 39, but the present invention is not limited to this aspect. A slight gap may be formed between the card edge 3 and the rear wall 39 due to manufacturing errors, for example. In addition, complete fitting between the edge connector 7 and the card edge 3 can be determined by electrical contact that is established between the terminal member 27 provided on the edge connector 7 and the corresponding pad 13 provided on the card edge 3, or by correct positioning of the terminal members 27 with respect to the corresponding pads 13.

LIST OF REFERENCE NUMERALS

| | |
|---|---|
| 1: connector assembly according to the first embodiment | |
| 3: card edge | 3A: first card edge |
| 3B: second card edge | 3C: third card edge |
| 5: card edge set according to the first embodiment | |
| 7: edge connector | 7A: first edge connector |
| 7B: second edge connector | 7C: third edge connector |
| 9: connector set according to the first embodiment | |
| 11: card edge insertion hole (insertion hole) | |
| 13: pad | 15: cutout |
| 15AL: first left cutout (first cutout) | 15AR: first right cutout (first cutout) |
| 15BL: second left cutout (second cutout) | 15BR: second right cutout (2nd cutout) |
| 15CL: third left cutout | 15CR: third right cutout |
| 17: card edge base part | 17S: abutting end surface |
| 19: card edge extension | 21: slot |
| 21A: first slot | 21B: second slot |
| 21C: third slot | 22: stepped part |
| 23: auxiliary slot | 25: housing |
| 25M: main body | 25N: protrusion |
| 27: terminal member | 31: upper wall |
| 31A: first upper wall | |
| 31B: second upper wall (incorrect insertion preventing wall) | |
| 33: lower wall | |
| 33A: first lower wall (incorrect insertion preventing wall) | |
| 33B: second lower wall | 35: left wall |
| 35A: first left wall | 35B: second left wall |
| 37: right wall | 37A: first right wall |
| 37B: second right wall | 39: rear wall |
| 39A: first rear wall | 39B: second rear wall |
| 41: partition wall | 40A: gap |
| 40B: slot | 40C: slot |
| 41A: first partition wall | 41B: second partition wall |
| 42A: locking piece | 42B: locking claw |
| 43: first projecting wall | 44: opening edge |
| 44A: opening edge | 44B: opening edge |
| 45: rib | 45S: inclined surface |
| 47: second projecting wall | 49: rib |
| 49S: inclined surface | 51: connector body |
| 59: terminal insertion hole | 59M: communication hole |
| 59N: retainer insertion hole | 61: lance piece |
| 61M: locking projection | 63: crimping part |
| 64: retainer | 65: housing |
| 65M: locking hole | 65N: opening |
| 67: spring piece | 67M: pressing portion |
| 67N: contact portion | 69: cable |
| 69M: conductor | |
| 81: connector assembly according to the second embodiment | |
| 83: connector set according to the second embodiment | |
| 85: card edge set according to the second embodiment | |
| 91: partition wall | |
| 91A: first partition wall (incorrect insertion preventing wall) | |
| 91B: second partition wall | 93: rib |
| 95A: cutout | 95B: cutout |
| 97: protrusion | |

1. A connector set including a first card edge connector and a second card edge connector,
wherein the first card edge connector and the second card edge connector each comprise a plurality of walls defining an insertion hole for receiving a corresponding end of a circuit board, and
at least one of the walls of the first card edge connector consists of an incorrect insertion preventing wall which has a rear end with respect to an insertion direction of the circuit board different from a corresponding rear end of the second card edge connector.

2. The connector set according to claim 1, wherein the incorrect insertion preventing wall defines an outer boundary of an end surface of the circuit board inserted into the insertion hole.

3. The connector set according to claim 1, wherein the incorrect insertion preventing wall forms a partition wall of the insertion hole.

4. The connector set according to claim 1, wherein the incorrect insertion preventing wall protrudes from the corresponding wall of the second card edge connector in a direction opposite to the insertion direction of the circuit board.

5. The connector set according to claim 1, wherein the first card edge connector and the second card edge connector each have an upper wall defining a boundary on a front side of the circuit board received in the insertion hole and a lower wall defining a boundary on a back side of the circuit board, and a rib is provided between the incorrect insertion preventing wall and at least one of the upper wall and the lower wall so as to connect these two parts.

6. A connector assembly, comprising the connector set according to claim 1, and a card edge set including a first card edge forming an end of the circuit board and configured to be inserted into the first card edge connector and a second card edge forming an end of the circuit board and configured to be inserted into the second card edge connector,
wherein the first card edge is provided with a first cutout cut out from an edge thereof in the insertion direction and configured to accept the incorrect insertion preventing wall, and the second card edge is provided with a second cutout cut out from an edge thereof in the insertion direction so as to accept the wall of the second card edge connector corresponding to the incorrect insertion preventing wall but not to accept the incorrect insertion preventing wall.

7. The connector assembly according to claim 6, wherein the first cutout has a longer cutout length than the second cutout.

8. A connector comprising a plurality of walls defining an insertion hole for receiving a corresponding end of a circuit board, the walls including an upper wall defining a boundary for a front side of the circuit board received in the insertion hole, a lower wall defining a back side of the circuit board, and an incorrect insertion preventing wall for preventing incorrect insertion of the circuit board into the insertion hole,
wherein the incorrect insertion preventing wall consists of at least one of a left wall and a right wall defining boundaries for a left side edge and right side edge of the circuit board received in the insertion hole, respectively, and a partition wall partitioning the insertion hole, and a rib is provided between the incorrect insertion preventing wall and at least one of the upper wall and the lower wall.
